(19) United States
(12) Patent Application Publication
(10) Pub. No.: US 2019/0030947 A1
(43) Pub. Date: Jan. 31, 2019

(54) VEHICLE WHEEL AND USE

(71) Applicants: THYSSENKRUPP STEEL EUROPE AG, Duisburg (DE); thyssenkrupp AG, Essen (DE)

(72) Inventor: David PIERONEK, Dortmund (DE)

(73) Assignees: THYSSENKRUPP STEEL EUROPE AG, Duisburg (DE); thyssenkrupp AG, Essen (DE)

(21) Appl. No.: 16/077,613

(22) PCT Filed: Feb. 10, 2017
(86) PCT No.: PCT/EP2017/053035

§ 371 Date: Aug. 13, 2018

(30) Foreign Application Priority Data
Feb. 17, 2016 (DE) 10 2016 202 381.0

(51) Int. Cl. B60B 3/04; B21D 53/30; B21H 1/02

(52) U.S. Cl. CPC B60B 3/041; B21D 53/30; B21H 1/02; B60B 2310/542; B60B 2360/102; B60B 2310/3026; B60B 2310/208; B60B 2310/211; B60B 2310/212; B60B 2310/226; B60B 2310/3023; B60B 2900/111

(57) ABSTRACT

A vehicle wheel may include a rim for receiving a tire and a wheel disk attached to the rim in a cohesive connection, in a force-fitting connection, and/or a form-fitting connection, with an attachment region for releasably attaching to a wheel mount. The wheel disk may be formed of a steel workpiece that is heat-treated at least in certain regions. To provide a utility vehicle wheel vehicle wheel having high operational strength and reliability relative to the prior art, the wheel disk may have at least in a transition region for attaching to the rim a heat-treated structure with at least one of a tensile strength of between 500 and 1300 MPa or a hardness of between 150 and 400 HV 0.1.

The invention relates to a vehicle wheel comprising a rim for receiving a tire and a wheel disk attached to the rim in a cohesive connection, force-fitting and/or form-fitting manner, with an attachment region for releasably attaching to a wheel mount, wherein the wheel disk is formed of a steel workpiece that is heat-treated at least in certain regions. The invention further relates to a use of the vehicle wheel.

Conventionally manufactured vehicle wheels, for example motor vehicle wheels, in particular of steel construction, consist of a rim for receiving a tire and a wheel disk that is attached to the rim in a cohesive connection, force-fitting and/or form-fitting manner and has an attachment region for releasably attaching to a wheel mount. Both the wheel disk and the rim can be produced by flow forming or flow turning. Flow forming has the advantage that the material, during forming, can be pressed from a constant starting material thickness in particular in a load- and/or weight-optimized manner, thus making it possible to establish different material thicknesses along the cross section at the wheel disk (in particular in the case of utility vehicle wheel disks) and at the rim (in particular in the case of car rims), which can contribute to a reduction in weight in comparison to wheel disks and/or rims of constant material thickness. In addition, the work hardening increases the material strength in the material. For example, it is possible to press at load-critical or stiffness-relevant points, that is to say to produce a local increase in the material thickness compared to the starting material thickness, and for the material thickness to be reduced at non-critical points.

In order to be able to achieve a further reduction in weight, one necessary approach is to use a material with greater strength or vibration resistance in order to reliably react the operating loads, and another is to adapt the geometry in order to compensate for the loss of stiffness owing to reduced workpiece thicknesses. However, the formability of the material generally decreases with increasing material strength. Thus, the lightweight construction with cold-formable steels encounters technical limits. In these cases, use can be made of “hot-forming”, which is also known in the field as indirect or direct hot-forming, by which it is possible to satisfy the requirement for high true strains and at the same time high strengths of the finally formed components.

Currently, materials with lightweight construction potential are heat-treatable steels, in particular hot-forming steels such as manganese-boron steels, which can react mechanical loads such as dynamic alternating loads. By way of prior art, in particular for the production of wheel disks from a hot-forming steel, which can be press-quenched at least in certain regions, reference is made to documents DE 10 2007 019 485 A1, DE 10 2013 114 245 B3 and DE 10 2014 108 901 B3. Document DE 10 2007 019 485 A1 proposes attaching the quenched individual components (rim/wheel disk) inter alia by welding or soldering. MAG welding, which is established in the field of vehicle wheel construction, melts the basic material and, in the case of hot-forming steels, produces additional tempering effects in the heat influence zone, forming a weakened zone (“hardness pocket”). This region of weakening in the region surrounding the welding region is characterized by low strength and ductility and forms a “metallurgic notch” which has a detrimental effect on the operational strength of the connection, or of the entire component, and can lead to premature failure, and as a result the material strength cannot globally be transferred to the entire vehicle wheel. In relation to the prior art, there is further potential for improvement, in particular with respect to high operational strength and reliability in vehicle wheels.

The invention was based on the object of providing a vehicle wheel having, in comparison to the known prior art, high operational strength and reliability, and a corresponding use.

According to a first aspect of the invention, the object is achieved as per the vehicle wheel according to the invention in that the wheel disk has, at least in the transition region for attaching to the rim, a heat-treated structure having a tensile strength of between 500 and 1300 MPa and/or a hardness of between 150 and 400 HV 0.1.

The inventor has established that using a heat-treated structure of the wheel disk, at least in the transition region for attaching to the rim, with a tensile strength of between 500 and 1300 MPa and/or a hardness of between 150 and 400 HV 0.1 (Vickers), it is possible to achieve a positive effect on the operational strength and reliability of the entire vehicle wheel, and to provide sufficient strength and ductility. A tensile strength of below 500 MPa, or a hardness of below 150 HV 0.1 is not sufficient for the required strength and vibration resistance of the vehicle wheel, and a tensile strength of greater than 1300 MPa, or a hardness of greater than 400 HV 0.1 are at the expense of the ductility and laudability of the connection between the wheel disk and the rim.

In particular, the heat-treated structure has a tensile strength of between 800 and 1200 MPa and/or a hardness of between 250 and 375 HV 0.1, preferably between 850 and 1100 MPa and/or a hardness of between 265 and 340 HV 0.1, particularly preferably between 900 and 1050 MPa and/or a hardness of between 280 and 325 HV 0.1, by means of which it is possible to ensure optimal operational strength and reliability of the vehicle wheel as a whole.

The wheel disk is attached to the rim in a cohesive connection, force-fitting and/or form-fitting manner. Preferably, the wheel disk is attached to the rim at least partially and in particular fully circumferentially at its edge by a joining seam, for example a fillet seam, which can be effected as a MIG, MAG, laser, weld or solder seam. Alternatively, the wheel disk can also be attached to the rim in its overlap/transition region by adhesive bonding and/or resistance welding. Alternatively or additionally, it is also conceivable to attach in a force-fitting manner using an (additional) press fit between the wheel disk and the rim in the overlap/transition region, in particular in order to relieve the load from additional connection means. Depending on the established strength/hardness in the transition region, the use of form-fitting, mechanical joining methods such as clinching, riveting or with functional elements is also possible. The wheel disk and the rim need not necessarily be attached in what is referred to as the “well base”. Wheel constructions such as semi- or full-face disk wheels, or of multi-part construction, are conceivable.

According to another embodiment of the vehicle wheel according to the invention, the wheel disk is made of a heat-treatable steel, in particular a hot-forming steel or an air-hardening steel. The stated steel alloys have the advantage that they are quenchable and in the corresponding component it is possible to establish a high hardness and/or high tensile strength. For essentially identical conditions, increasing strength makes it possible to further reduce the respective material thickness, and thus further reduce the weight. In addition, they have higher cyclical flexural fatigue strength, which is advantageous in particular in the form of greater service life of the corresponding components, and thus in particular premature material failure by crack formation can be largely prevented. It is also conceivable to use a composite material with for example three steel layers, of which at least one layer can be heat-treated and in particular quenched. It is to be noted that the tensile strength or hardness is averaged over the material thickness, especially also if a monolithic material is skin-layer hardened.

According to another embodiment of the vehicle wheel according to the invention, the heat-treated structure having a tensile strength of between 500 and 1300 MPa and/or a hardness of between 150 and 400 HV extends from the transition region at least in certain regions into a first region in which openings can optionally be provided. The expansion of the heat-treated structure into a further region can have a positive effect on the transfer of forces with frequent load reversals from the tire mounted on the rim into the wheel mount, in particular owing to the (high) notch effect of the introduced ventilation holes. It is further possible, if the heat-treated structure completely fills the first region and openings are provided in the first region, for subsequent stamping of the openings after completion of the final geometry of the wheel disk to be simplified, for example with little mechanical tool wear. The openings act for example as ventilation holes and/or reduce the overall weight of the vehicle wheel by stamping out or omitting material in a targeted manner.

According to another embodiment of the vehicle wheel according to the invention, the heat-treated structure having a tensile strength of between 500 and 1300 MPa and/or a hardness of between 150 and 400 HV 0.1 is provided in a second region at least in certain regions. The second region can for example comprise the attachment region for releasably attaching to a wheel mount, in which there are provided openings for receiving connection means (bolts/screws). This has, for example, the advantage that, in the region of the attachment face for the connection means, local stress concentrations can be evened out or distributed over a large surface area into surrounding regions, and it is thus possible to reduce the notch sensitivity, and as a result, in the case of components subjected to oscillating loads, the service life of the entire system can be increased.

According to another embodiment of the vehicle wheel according to the invention, the wheel disk comprises at least a third region which has a structure with a tensile strength of greater than 1300 MPa and/or a hardness of greater than 400 HV 0.1, in particular a (press-) quenched structure. The third region can for example be provided between the attachment region for releasably attaching to a wheel mount (second region) and the first region which adjoins the transition region for attaching to the rim, and serves for local/overall stiffening of the wheel disk.

According to another embodiment of the vehicle wheel according to the invention, the complete wheel disk has a heat-treated structure having a tensile strength of between 500 and 1300 MPa and/or a hardness of between 150 and 400 HV 0.1, which provides homogeneous strength/hardness in the wheel disk subjected to oscillating loads, and by which metallurgical notches can be largely prevented.

According to another embodiment of the vehicle wheel according to the invention, the rim is made of a heat-treatable steel, in particular a hot-forming steel or an air-hardening steel, and has, at least in certain regions, a heat-treated structure having a tensile strength of between 500 and 1300 MPa and/or a hardness of between 150 and 400 HV 0.1, for example in a region in which the wheel disk lies against and/or is pressed in and attached with its transition region. It is also conceivable to use a composite material with for example three steel layers, of which at least one layer can be heat-treated and in particular quenched. The operational strength and reliability of the vehicle wheel can be increased when using the above-mentioned steels as the material for the rim. It is also possible for other regions to have a heat-treated structure, individually and depending on the embodiment of the rim. For example, the region forming what is referred to as the rim flange has a heat-treated structure which is provided at least on that side oriented away from the wheel mount in the mounted state of the vehicle wheel in order to avoid total damage in the event of curb contact. Alternatively, the entire rim can have a heat-treated structure having a tensile strength of between 500 and 1300 MPa and/or a hardness of between 150 and 400 HV 0.1.

According to another embodiment of the vehicle wheel according to the invention, the wheel disk and/or the rim are formed by compressive forming, tensile forming, tensile-compressive forming, bending, shear forming, flow forming or deep drawing, in particular by hot-forming with optionally at least partial (press-) quenching, or by means of a combination of the stated manufacturing methods, wherein the heat-treated structure at least in the transition region of the wheel disk for attachment to a rim and/or at least in a region in the rim is established prior to, during and/or after a forming operation by heat treatment at least in certain regions.

By choosing suitable steel materials, preferably one of the previously mentioned steels, also conceivable in multiple layers as a composite material, it is possible, in combination with an at least local and tailored heat treatment, to establish in a targeted manner heat-treated structures having a tensile strength of between 500 and 1300 MPa and/or a hardness of between 150 and 400 HV 0.1. The at least locally heat-treated structure can be established for example during the indirect and also direct hot-forming, for example by avoiding heating of the relevant region above the Ac₃ temperature of the material so that, during the subsequent (press-) quenching in a fully cooled tool or using other suitable means for quenching, no fully quenched structure is formed. For example, the relevant region can be partially austenized, that is to say heated to a temperature range between Ac₁ and Ac₃. Alternatively or additionally, it is possible to use a suitable means to avoid abrupt cooling in the relevant region, for example using temperature-controlled sections in a tool for hot-forming and/or (press-) quenching. The heat-treated structure consists for example of at least two of the following phases: ferrite, perlite, bainite, austenite and martensite; in particular predominantly ferrite with at least one of the following phases: perlite, bainite, austenite and martensite.

For example, the material or composite material can in particular be heated to above the Ac₁ temperature, preferably to above the Ac₃ temperature, hot-formed and at least locally press-quenched (direct hot-forming) or for example cold-formed, in which context the die, which essentially corresponds to the final geometry of the corresponding component, is heated to above the Ac₁ temperature, preferably to above the Ac₃ temperature, and then at least locally quenched (indirect hot-forming). The at least locally heat-treated structure can subsequently be established by heat treatment of the relevant regions, which for example have predominantly martensite in the structure, in particular by tempering or heating by suitable means, for example using inductors, furnaces, lasers, contact heating or burners. The heat-treated structure can be established locally or universally in the finished component after hot-forming or cold-forming with subsequent heating for example to a partial austenizing temperature and without active or abrupt cooling, but rather merely by air cooling (air-hardening). Other heat-treatment methods, which are not mentioned here and which are suitable for establishing a heat-treated structure having the previously mentioned properties, are also conceivable.

The second aspect of the invention relates to a use of the vehicle wheel in cars, utility vehicles, goods vehicles, special-purpose vehicles, buses, omnibuses, whether with an internal combustion engine and/or electric drive, or trailers. Depending on the vehicle type, the vehicle wheel, with its wheel disk and rim, is configured in a load- and/or weight-optimized manner, with appropriate material thicknesses that can also vary along the respective cross section.

There follows a more detailed explanation of the invention with reference to a drawing representing exemplary embodiments. Identical parts are provided with identical reference signs. In the figures:

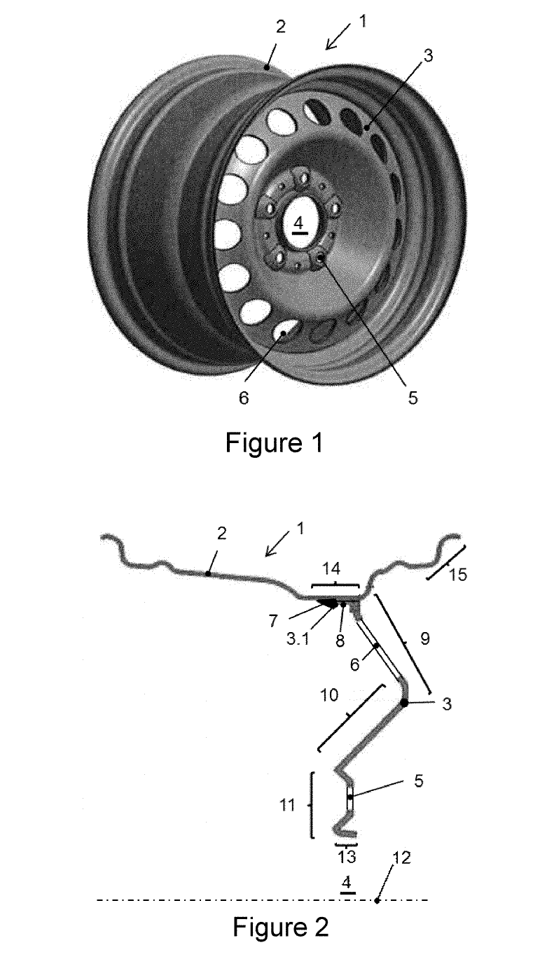

FIG. 1 is a perspective illustration of a vehicle wheel according to the invention, and

FIG. 2 shows a partial cross section through the vehicle wheel of FIG. 1.

FIG. 1 shows, in a perspective view, an exemplary embodiment of a vehicle wheel (1) according to the invention, for example for a car. FIG. 2 shows a partial cross section through the vehicle wheel (1), in which, owing to the rotationally symmetric design, only the upper region of the vehicle wheel (1) above the axis of symmetry (12) is depicted in section. The vehicle wheel (1) comprises an in particular profiled rim (2) for receiving a tire (not shown), and a wheel disk (3) that is attached to the rim (2) in a cohesive connection, form-fitting and/or force-fitting manner. As shown in detail in FIG. 2, the wheel disk (3) is preferably attached to the rim (2) at least partially along its edge (3.1) by means of a joining seam (7), for example a fillet seam, which can be effected as a MIG, MAG, laser, weld or solder seam. Alternatively, the wheel disk can also be attached to the rim in its overlap/transition region by adhesive bonding and/or resistance welding and/or be means of a mechanical connection. Additionally, it is also provided to attach in a force-fitting manner in the overlap/transition region using a press fit, thus making it possible to relieve load from the joining seam during operation.

The wheel disk (3) is made of a hot-forming steel or an air-hardening steel, which have the advantage of being quenchable, and a high hardness and/or high tensile strength can be established in the corresponding component and thus the corresponding component can have greater cyclical flexural fatigue strength. It is also conceivable to use a composite material with for example three steel layers, of which at least one layer is heat-treatable, in particular quenchable.

The wheel disk (3) is in the form of a disk and comprises an at least partially and preferably fully circumferential angled end region which forms the transition region (8) for attaching to the rim (2). According to the invention, at least the transition region (8) has a heat-treated structure having a tensile strength of between 500 and 1300 MPa and/or a hardness of between 150 and 400 HV 0.1, which has a positive effect on the operational strength and reliability of the vehicle wheel, and provides sufficient strength and ductility or vibration resistance. The wheel disk (3) is formed by compressive forming, tensile forming, tensile-compressive forming, bending, shear forming, flow forming or deep drawing, in particular by hot-forming with optionally at least partial (press-) quenching, or by a combination of the stated production methods, wherein the heat-treated structure at least in the transition region (8) of the wheel disk (3) can be established prior to, during and/or after a forming operation by heat treatment at least in certain regions. By choosing suitable steel materials, preferably one of the previously mentioned steels, also in multiple layers as a composite material, it is possible, in combination with an at least local and tailored heat treatment, to establish, in the wheel disk (3), structures, heat-treated in a targeted manner, having a tensile strength of between 500 and 1300 MPa and/or a hardness of between 150 and 400 HV 0.1. For the establishment of the heat-treated structures, reference is made to the explanations in the general portion of the description, which merely indicate examples.

Adjoining the transition region (8) is a first region (9) in which there are provided, distributed around the circumference, openings (6) which act for example as ventilation holes and/or reduce the overall weight of the vehicle wheel (1) by stamping out or omitting material in a targeted manner. A preferably at least local expansion of the heat-treated structure from the transition region (8) into the first region (9) can have a positive effect on the transfer of forces with frequent reversals, in operation, from the tire mounted on the rim (2) into the wheel mount. It is further possible, if the heat-treated structure completely fills the first region (9), for subsequent stamping of the openings after completion of the final geometry of the wheel disk (3) to be simplified, for example with little mechanical tool wear.

The wheel disk (3) comprises a second region (11) which for example forms the attachment region for releasably attaching to a wheel mount, and in which there are provided openings (5) for receiving connection means (bolts/screws, not shown). The second region (11) adjoins a central opening (4) of the wheel disk (3) which for example serves for centering the wheel on a wheel hub (not shown) which is a component of a wheel mount (not shown). The central opening (4) is defined by a collar-shaped region (13). If the second region (11) has a heat-treated structure, this has, for example, the advantage that, in the region of the attachment face (11.1) for the connection means, local stress concentrations can be evened out or distributed over a large surface area into the surrounding region (13, 10), and it is thus possible to reduce the notch sensitivity.

The wheel disk (3) comprises at least a third region (10) which has a structure with a tensile strength of greater than 1300 MPa and/or a hardness of greater than 400 HV 0.1, in particular a (press-) quenched structure. The third region (10) is located between the attachment region for releasably attaching to a wheel mount (second region (11)) and the first region (9) which adjoins the transition region (8), and serves for local/overall stiffening of the wheel disk. The collar-shaped region (13) can, depending on the vehicle wheel type and requirement, have a heat-treated structure or be quenched.

Alternatively, and not depicted here, the entire wheel disk can have a heat-treated structure having a tensile strength of between 500 and 1300 MPa and/or a hardness of between 150 and 400 HV 0.1, which provides homogeneous strength and/or hardness in the wheel disk subjected to oscillating loads, and by which metallurgical notches can be largely prevented.

If use is made of a rim (2) which is formed of a hot-forming steel or an air-hardening steel, it preferably has, at least locally in a region (14), a heat-treated structure having a tensile strength of between 500 and 1300 MPa and/or a hardness of between 150 and 400 HV 0.1, in which the wheel disk (3) lies against with its transition region (8) and/or is pressed in and attached by means of a joining seam (7). It is also conceivable to use alternative joining methods, and to use a composite material with for example three steel layers, of which at least one layer is heat-treatable, in particular quenchable. The operational strength and reliability of the vehicle wheel can be increased when using the previously mentioned steels as the material for the rim. For example, the region (15) forming what is referred to as the rim flange has a heat-treated structure which is provided at least on that side oriented away from the wheel mount in the mounted state of the vehicle wheel (1) in order to avoid total damage to the rim (2) or to the vehicle wheel (1) in the event of curb contact. Where necessary, it is also possible for a heat-treated structure having a tensile strength of between 500 and 1300 MPa and/or a hardness of between 150 and 400 HV 0.1 to be established in the entire rim. For the establishment of the at least locally heat-treated structures in the rim (2), reference is made to the explanations relating to the wheel disk (3).

In order to ensure optimal operational strength and reliability of the entire vehicle wheel (1), the heat-treated structure of the transition region (8), of the first region (9) and/or of the second region (11), or alternatively of the entire wheel disk and/or rim, has a tensile strength of between 800 and 1200 MPa and/or a hardness of between 250 and 375 HV 0.1, preferably of between 850 and 1100 MPa and/or a hardness of between 265 and 340 HV 0.1, particularly preferably of between 900 and 1050 MPa and/or a hardness of between 280 and 325 HV 0.1. The heat-treated structure consists for example of at least two of the following phases: ferrite, perlite, bainite, austenite and martensite; in particular predominantly ferrite with at least one of the following phases: perlite, bainite, austenite and martensite. Alternatively, the heat-treated structure can for example have predominantly martensite, in particular tempered martensite.

The invention is not restricted to the exemplary embodiments depicted in the drawing, or to the explanations in the general description, and rather it is also possible for the rim (2) and/or the wheel disk to be formed from a Tailored Product, for example a Tailored Blank and/or a Tailored Rolled Blank. Depending on the vehicle type, the vehicle wheel, with its wheel disk and rim, is configured in a load- and/or weight-optimized manner, with appropriate material thicknesses that can also vary along the respective cross section. Particularly advantageously, the invention can also find application in the context of utility vehicle wheels.

### LIST OF REFERENCE SIGNS

1 Vehicle wheel
2 Rim
3 Wheel disk
3.1 Circumferential edge of the wheel disk
4 Central opening
5 Opening for receiving connection means
6 Opening, ventilation opening
7 Fillet seam
8 Transition region for attaching to the rim
9 First region
10 Third region
11 Second region, attachment region for releasably attaching to a wheel mount
11.1 Attachment face for the connection means
12 Axis of symmetry
13 Collar-shaped region
14 A region of the rim
15 Region forming the rim flange

1.-10. (canceled)

11. A vehicle wheel comprising:
a rim configured to receive a tire; and
a wheel disk attached to the rim by at least one of a cohesive connection, a force-fitting connection, or a form-fitting connection, the wheel disk comprising an attachment region configured to be releasably attached to a wheel mount, wherein the wheel disk is comprised of a steel workpiece that is heat-treated at least in some regions, wherein the wheel disk comprises at least in a transition region configured to be attached to the rim a heat-treated structure with at least one of a tensile strength between 500 and 1300 MPa or a hardness between 150 and 400 HV 0.1.

12. The vehicle wheel of claim 11 wherein the tensile strength of the heat-treated structure if between 800 MPa and 1200 MPa.

13. The vehicle wheel of claim 11 wherein the tensile strength of the heat-treated structure if between 900 MPa and 1050 MPa.

14. The vehicle wheel of claim 11 wherein the hardness of the heat-treated structure if between 250 HV 0.1 and 375 HV 0.1.

15. The vehicle wheel of claim 11 wherein the hardness of the heat-treated structure if between 280 HV 0.1 and 325 HV 0.1.

16. The vehicle wheel of claim 11 wherein the wheel disk is comprised of a hot-forming steel.

17. The vehicle wheel of claim 11 wherein the wheel disk is comprised of an air-hardening steel.

18. The vehicle wheel of claim 11 wherein the heat-treated structure extends at least in part from the transition region of the wheel disk into a first region of the wheel disk that comprises ventilation holes.

19. The vehicle wheel of claim 18 wherein the heat-treated structure extends at least in part from the transition region of the wheel disk into a second region of the wheel disk that comprises ventilation holes.

20. The vehicle wheel of claim 19 wherein the wheel disk comprises a third region that has a structure with at least one of a tensile strength of more than 1300 MPa or a hardness of more than 400 HV 0.1.

21. The vehicle wheel of claim 19 wherein the wheel disk comprises a third region that has a press-quenched structure.

22. The vehicle wheel of claim 19 wherein the wheel disk comprises a third region that has a press-quenched structure with at least one of a tensile strength of more than 1300 MPa or a hardness of more than 400 HV 0.1.

23. The vehicle wheel of claim 11 wherein the heat-treated structure extends of an entirety of the wheel disk.

24. The vehicle wheel of claim 11 wherein the rim is comprised of a heat-treatable steel, the rim including in a region a heat-treated structure with at least one of a tensile strength between 500 and 1300 MPa or a hardness between 150 and 400 HV 0.1, wherein the transition region of the wheel disk lies against and/or is pressed in and attached to the heat-treated structure of the rim.

25. The vehicle wheel of claim 24 wherein the heat-treated structure of the region of the wheel disk is established prior to a forming operation by heat treatment at least in certain regions.

26. The vehicle wheel of claim 11 wherein at least one of the wheel disk or the rim is formed by hot-forming with at least partial press-quenching.

27. The vehicle wheel of claim 11 wherein at least one of the wheel disk or the rim is formed by compressive forming, tensile forming, tensile-compressive forming, bending, shear forming, flow forming, or deep drawing.

28. The vehicle wheel of claim 27 wherein the heat-treated structure at least in the transition region of the wheel disk is established prior to a forming operation by heat treatment at least in certain regions.

29. The vehicle wheel of claim 27 wherein the heat-treated structure at least in the transition region of the wheel disk is established during a forming operation by heat treatment at least in certain regions.

30. The vehicle wheel of claim 27 wherein the heat-treated structure at least in the transition region of the wheel disk is established after a forming operation by heat treatment at least in certain regions.
